(19) United States
(12) Patent Application Publication
(10) Pub. No.: US 2009/0006089 A1
(43) Pub. Date: Jan. 1, 2009

(54) METHOD AND APPARATUS FOR STORING REAL TIME INFORMATION ON A MOBILE COMMUNICATION DEVICE

(75) Inventors: Daryoosh SHENASSA, Libertyville, IL (US); Changxue Ma, Barrington, IL (US); Deborah A. Matteo, Schaumburg, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/769,226

(22) Filed: Jun. 27, 2007

(51) Int. Cl. G10L 15/26

(52) U.S. Cl. 704/235; 704/E15.043

(57) ABSTRACT

A method and apparatus that stores information on a mobile communication device is disclosed. The method may include receiving a first signal from a user, initiating a recording of information spoken by at least one of the user, a voice mail recording, a recorded message, and a party engaged in the telephone call with the user based on the received first signal, receiving a second signal from the user, stopping the recording of the information based on the second signal being received, converting the recorded information to text, and storing the converted text to a designated location.

### BACKGROUND OF THE DISCLOSURE

1. Field of the Disclosure

The disclosure relates to mobile communication devices and in particular, to storing information receiving during telephone communications on the mobile communication device.

2. Introduction

Often the user of a cell phone needs to write down some information that is exchanged during a phone call conversation such as names, telephone numbers, addresses, etc. At times this would be difficult to do because the conversation might take place while the user is driving or walking, or the user has to enter the information (or part of it) back into the phone for later use, for example.

When the user of a cell phone listens to a new received voice message, the user often needs to write down the name and the phone number embedded in the message. While the user can easily grasp the content of the message, it is often difficult to understand the exact name and telephone number that a caller has left in the message—sometimes the most important part of the voice message. Thus, the user has to playback the voice message a few times to extract the exact name and/or telephone number and then add them to the phone book manually. Moreover, this is time-consuming since callers do not necessarily say their name and/or telephone at the beginning of the message they leave. In fact, quite often the name is at the beginning of the message while the number is at the end. Thus, in the case of the telephone number, quite often the user has to listen to the entire message repeatedly hoping to extract and write down the exact telephone number at the end of the message.

### SUMMARY OF THE DISCLOSURE

A method and apparatus that stores information on a mobile communication device is disclosed. The method may include receiving a first signal from a user, initiating a recording of information spoken by at least one of the user, a voice mail recording, a recorded message, and a party engaged in the telephone call with the user based on the received first signal, receiving a second signal from the user, stopping the recording of the information based on the second signal being received, converting the recorded information to text, and storing the converted text to a designated location.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates an exemplary diagram of a mobile communication device in accordance with a possible embodiment of the disclosure;

FIG. 2 illustrates a block diagram of an exemplary mobile communication device in accordance with a possible embodiment of the disclosure; and

FIG. 3 is an exemplary flowchart illustrating one possible information storage process in accordance with one possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure comprises a variety of embodiments, such as a method and apparatus and other embodiments that relate to the basic concepts of the disclosure.

This disclosure concerns a mobile communication device application having a push-to-keep module that includes automatic speech recognition (ASR) modules whereby the user may record important information and have it stored in text form in real time. The user may listen to the calling party or a recorded voice message and press a push-to-keep button while he/she hears the calling party providing information, such as a name, telephone number, address, etc. Thus, the user marks the beginning and the end of the parts of the message in which he/she is interested. In the case of listening to a calling party, the user may repeat the information by echoing back the information for conformation (similar to when a user writes down a piece of information while talking over the phone).

Once the push-to-keep button is pressed, the ASR may extract the parts of the speech data, perform recognition, and produces the recognition results in text form. The mobile communication device may display the information (name, number, address, etc.) on the screen, or repeats them for the user. The user may be asked if the information (name, number, address, etc.) should be added to the phone book or any other database in the phone. The user may also immediately act upon the captured/displayed information (name, number, address, etc.) as appropriate, e.g., calling back, sending SMS, adding to phone book, adding to calendar, etc.

The application may handle any voice mail boxes the user may possess. For example, the message may be stored in the user's mobile communication device, the user's network (i.e., the message was sent to user's cell phone), or in the user's land-line phone/network (i.e., the message was sent to user's home or office), as long as the user uses the mobile communication device with the push-to-keep application to recognize the information.

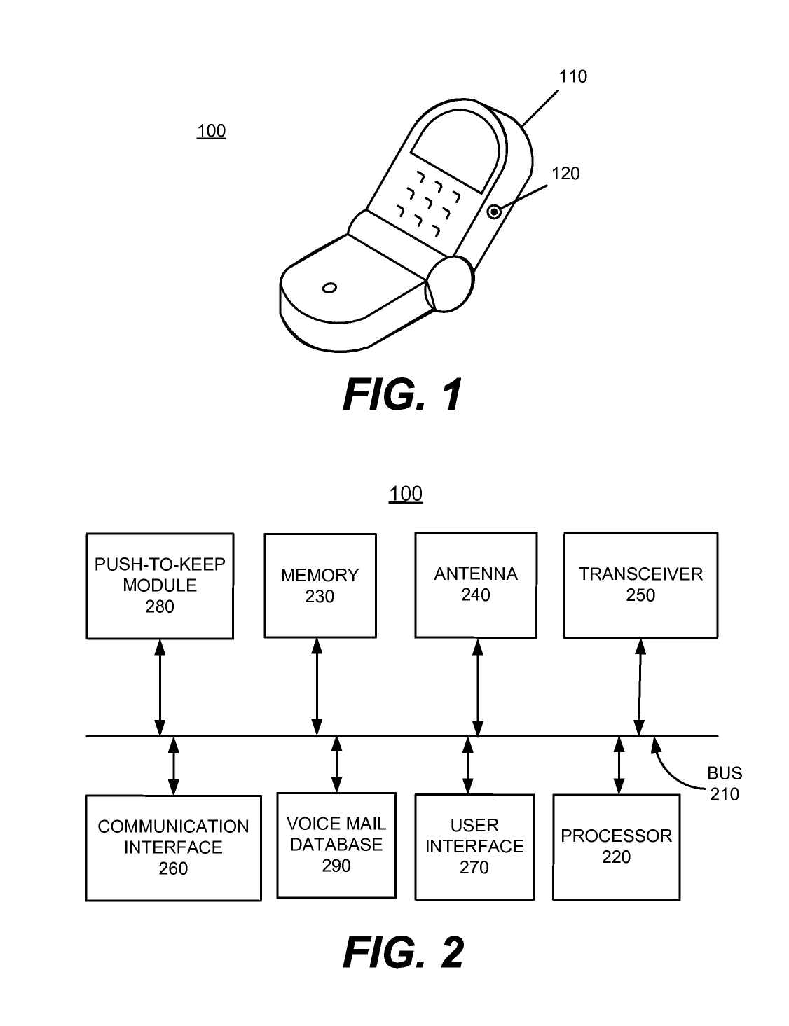

FIG. 1 illustrates an exemplary diagram of a mobile communication device 100 in accordance with a possible embodiment of the disclosure. The mobile communication device 100 may include a chassis 110 and a push-to-keep button 120. Note that while the exemplary diagram shows only one push-to-keep button 120 on the side of the chassis 110, one of skill may appreciate that there may be more than one push-to-keep button 120. Moreover, the push to keep button(s) 110 may be located on other locations on the chassis 110, including the face of the mobile communication device 100, on a touch screen display, etc. The push-to-keep button 120 may also be one function of a multi-function button.

The mobile communication device 110 may be a portable MP3 player, satellite radio receiver, AM/FM radio receiver, satellite television, portable music player, portable computer, wireless radio, wireless telephone, portable digital video recorder, cellular telephone, mobile telephone, personal digital assistant PDA), or combinations of the above, for example.

FIG. 2 illustrates a block diagram of an exemplary mobile communication device 100 in accordance with a possible embodiment of the invention. The mobile communication device 100 may include a bus 210, a processor 220, a memory 230, an antenna 240, a transceiver 250, a communication interface 260, a user interface 270, and a push-to-keep module 280. Bus 210 may permit communication among the components of the mobile communication device 100.

Processor 220 may include at least one conventional processor or microprocessor that interprets and executes instructions. Memory 230 may be a random access memory (RAM or another type of dynamic storage device that stores information and instructions for execution by processor 220. Memory 230 may also include a read-only memory (ROM which may include a conventional ROM device or another type of static storage device that stores static information and instructions for processor 220.

Transceiver 250 may include one or more transmitters and receivers. The transceiver 250 may include sufficient functionality to interface with any network or communications station and may be defined by hardware or software in any manner known to one of skill in the art. The processor 220 is cooperatively operable with the transceiver 250 to support operations within one or more communications network. The transceiver 250 transmits and receives transmissions via one or more of the antennae 240 in a manner known to those of skill in the art.

Communication interface 260 may include any mechanism that facilitates communication via one or more communications network. For example, communication interface 260 may include a modem. Alternatively, communication interface 260 may include other mechanisms for assisting the transceiver 250 in communicating with other devices and/or systems via wireless connections.

User interface 270 may include one or more conventional input mechanisms that permit a user to input information, communicate with the mobile communication device 100, and/or present information to the user, such as a an electronic display, microphone, touchpad, keypad, keyboard, mouse, pen, stylus, voice recognition device, buttons, one or more speakers, etc.

Voice mail database 290 is a database of voice mail recordings stored on the mobile communication device 100. These voice mail recordings may be called up by the push-to-keep module 280 and at least portions thereof converted to text, as discussed further below.

The mobile communication device 100 may perform such functions in response to processor 220 and/or push-to-keep module 280 by executing sequences of instructions contained in a computer-readable medium, such as, for example, memory 230. Such instructions may be read into memory 230 from another computer-readable medium, such as a storage device or from a separate device via communication interface 260.

For illustrative purposes, the functions of the push-to-keep module 280 and the information storage process will be described below in relation to the diagrams shown in FIGS. 1-2.

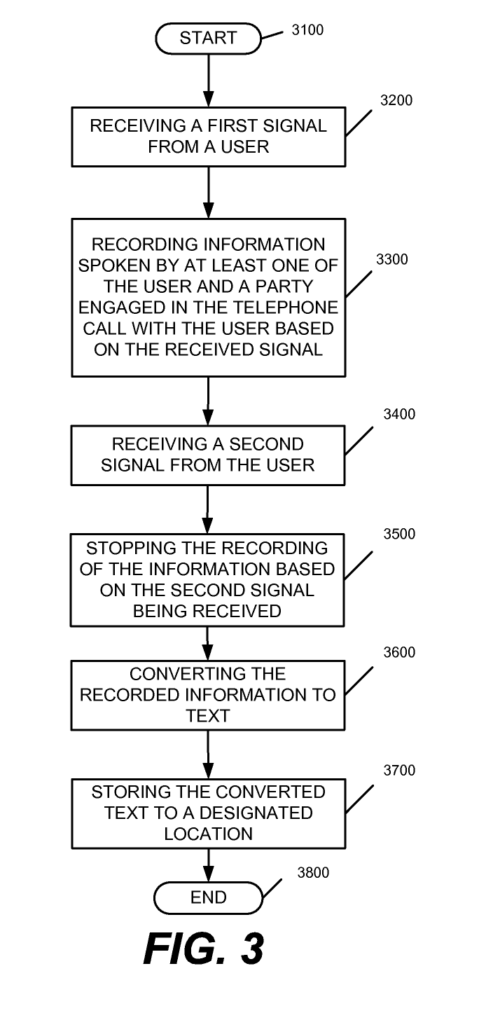

FIG. 3 is an exemplary flowchart illustrating some of the basic steps associated with information storage process in accordance with a possible embodiment of the disclosure. The process begins at step 3100 and continues to step 3200 where the push-to-keep module 280 receives a first signal from a user. The first signal may be the result of a user pressing a push-to-keep button 120 on the mobile communication device 100, for example. At step 3300, the push-to-keep module 280 records information spoken by at least one of the user, a voice mail recording, a recorded message, or a party engaged in the telephone call with the user based on the received signal. The information may be recorded by any means known to one of skill in the art, including to an audio file saved in memory 230, for example. The information may include names, telephone numbers, numbers, dates, times, locations, events, participants, etc. In this regard, the user may be prompted to select a category prior to speaking or paying the information so that the information may be converted to text and stored in the desired location and/or using the desired application, as discussed below.

At step 3400, the push-to-keep module 280 receives a second signal from the user. The second signal may be the result of a user pressing a push-to-keep button 120 on the mobile communication device 100, for example. This signal may also be the result of pressing the same or a different button that the button generating the first signal.

At step 3500, the push-to-keep module 280 stops the recording of the information based on the second signal being received. Note that the push-to-keep button 120 may be pressed and released several times during a single call, message, etc. if the user decides he or she needs multiple pieces of information. Information is recorded with each initial press of the push-to keep button 120 and recording is stopped with a subsequent pressing of the push-to keep button 120. In this manner, a user can record names, numbers, events, times, locations, etc. from a single message, telephone call, etc.

At step 3600, the push-to-keep module 280 converts the recorded information to text. The push-to-keep module 280 may include or interact with one or more voice recognition modules to recognize the user's voice, a caller's voice, a voice off of voice mail, etc. and convert that speech to text. The voice recognition modules may use any automated speech recognition (ASR) algorithm or methods known to those of skill in the art. At step 3700, the push-to-keep module 280 stores the converted text to a designated location. The designated location may be an address book, a calendar, a mobile communication device memory, a flash memory, a note pad, a redial memory, an external memory, a display, and a memo pad. The process goes to step 3800 and ends.

Below are a few examples of how this process may be utilized:

### EXAMPLE DIALOG #1: KEEPING A NAME AND PHONE NUMBER WHILE IN A CALL

Caller (other party): “you have to talk to Megan this afternoon.”
User: (Push-to-keep button pressed) “What is her name again?” (Push-to-keep released)
Caller: “Megan Matthews”
User: Push-to-keep pressed) “Megan Matthews” (Push-to-keep released)
User: “What is her phone number?”
Caller: 1-234-567-8901
User (Push-to-keep pressed) “1-2-3-4-5-6-7-8-9-0-1” Push-to-keep released)

### EXAMPLE DIALOG #2: KEEPING A NUMBER FROM DIRECTORY ASSISTANCE

User: [dials directory assistance, i.e, 4-1-1]
Directory Assistance Operator: “City and State, please.”
User: “Annapolis, Md.” I need the number for the (Push-to-keep pressed) “Naval Academy” (Push-to-keep released)
Directory Assistance Operator: “The number is 9-8-7-6-5-4-3-2-1-0?”
User (Push-to-keep pressed) “9-8-7-6-5-4-3-2-1-0” (Push-to-keep released)

### EXAMPLE DIALOG #3: CREATING APPOINTMENTS FROM VOICE NOTES

User: [while in the Calendar Application]
User: Push-to-keep pressed) “7-p-m” (Push-to-keep released),
User: Push-to-keep pressed) “swimming” (Push-to-keep released),
[Calendar App]: Opens up a new event with the time starting at 7 pm and the topic populated with ‘swimming’.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the push-to-keep module 280 in FIG. 2 each processing the content in various possible ways. It does not necessarily need to be one system used by all end users. Accordingly, the appended claims and their legal equivalents should only define the disclosure, rather than any specific examples given.

We claim:

1. A method for storing information on a mobile communication device, comprising:
receiving a first signal from a user;
initiating a recording of information spoken by at least one of the user, a caller on a voice mail recording, a recorded message, and a party engaged in the telephone call with the user based on the received first signal;
receiving a second signal from the user;
stopping the recording of the information based on the second signal being received;
converting the recorded information to text; and
storing the converted text to a designated location.

2. The method of claim 1, wherein at least one of the first and second signals is generated by at least one button being pressed on the mobile communication device.

3. The method of claim 1, wherein the designated location is at least one of an address book, calendar, a mobile communication device memory, a flash memory, a note pad, a redial memory, an external memory, a display, and a memo pad.

4. The method of claim 1, further comprising:
selecting the converted text;
selecting the designated location to store the converted text; and
storing the converted text to the selected designated location.

5. The method of claim 1, further comprising:
selecting the converted text, the converted text being at least one of a name and a phone number; and
dialing one of the phone number and phone number associated with the name.

6. The method of claim 1, further comprising:
searching an address book for the converted text; and
displaying search results on the mobile communication device.

7. The method of claim 1, wherein the mobile communication device is at least one of a portable MP3 player, a satellite radio receiver, an AM/FM radio receiver, a satellite television, a portable music player, a portable computer, a wireless radio, a wireless telephone, a portable digital video recorder, a cellular telephone, a mobile telephone, and a personal digital assistant.

8. An apparatus that stores information on a mobile communication device, comprising:
a memory; and
a push-to-keep module that receives a first signal from a user, initiates a recording of information spoken by at least one of the user, a caller on a voice mail recording, a recorded message, and a party engaged in the telephone call with the user based on the received first signal, receives a second signal from the user, stops the recording of the information based on the second signal being received, converts the recorded information to text, and stores the converted text to a designated location in the memory.

9. The apparatus of claim 8, wherein at least one of the first and second signals is generated by at least one button being pressed on the mobile communication device.

10. The apparatus of claim 8, wherein the designated location is at least one of an address book, calendar, a mobile communication device memory, a flash memory, a note pad, a redial memory, an external memory, a display, and a memo pad.

11. The apparatus of claim 8, wherein the push-to-keep module selects the converted text, selects the designated location in memory to store the converted text, and stores the converted text to the selected designated location in the memory.

12. The apparatus of claim 8, wherein the push-to-keep module selects the converted text, the converted text being at least one of a name and a phone number, and dials one of the phone number and phone number associated with the name.

13. The apparatus of claim 8, wherein the push-to-keep module searches an address book for the converted text, and displays search results on the mobile communication device.

14. The apparatus of claim 8, wherein the mobile communication device is at least one of a portable MP3 player, a satellite radio receiver, an AM/FM radio receiver, a satellite television, a portable music player, a portable computer, a wireless radio, a wireless telephone, a portable digital video recorder, a cellular telephone, a mobile telephone, and a personal digital assistant.

15. A mobile communication device, comprising:
a memory;
at least one button that functions as a push-to-keep button located on the mobile communication device; and
a push-to-keep module that receives a first signal from the push-to-keep button, initiates a recording of information spoken by at least one of the user, a caller on a voice mail recording, a recorded message, and a party engaged in the telephone call with the user based on the received first signal, receives a second signal from the push-to-keep button, stops the recording of the information based on the second signal being received, converts the recorded information to text, and stores the converted text to a designated location in the memory.

16. The mobile communication device of claim 15, wherein the designated location is at least one of an address book, calendar, a mobile communication device memory, a flash memory, a note pad, a redial memory, an external memory, a display, and a memo pad.

17. The mobile communication device of claim 15, wherein the push-to-keep module selects the converted text, selects the designated location in memory to store the converted text, and stores the converted text to the selected designated location in the memory.

18. The mobile communication device of claim 15, wherein the push-to-keep module selects the converted text, the converted text being at least one of a name and a phone number, and dials one of the phone number and phone number associated with the name.

19. The mobile communication device of claim 15, wherein the push-to-keep module searches an address book for the converted text, and displays search results on the mobile communication device.

20. The mobile communication device of claim 15, wherein the mobile communication device is at least one of a portable MP3 player, a satellite radio receiver, an AM/FM radio receiver, a satellite television, a portable music player, a portable computer, a wireless radio, a wireless telephone, a portable digital video recorder, a cellular telephone, a mobile telephone, and a personal digital assistant.
